(19) United States
(12) Patent Application Publication
(10) Pub. No.: US 2019/0096150 A1
(43) Pub. Date: Mar. 28, 2019

(54) REMOTE BUTTON FOR GARAGE DOOR OPENER TRANSMITTER

(71) Applicant: Panasonic Automotive Systems Company of America, Division of Panasonic Corporation of North America, Peachtree City, GA (US)

(72) Inventor: VISHWAS D. KULKARNI, ROCHESTER HILLS, MI (US)

(73) Assignee: Panasonic Automotive Systems Company of America, Division of Panasonic Corporation of North America

(21) Appl. No.: 16/143,183

(22) Filed: Sep. 26, 2018

Related U.S. Application Data
(60) Provisional application No. 62/563,517, filed on Sep. 26, 2017.

(51) Int. Cl. G07C 9/00

(52) U.S. Cl. CPC G07C 9/00182; G07C 2009/00928; G07C 2009/00769

(57) ABSTRACT

A garage door opener arrangement for a motor vehicle includes a mobile, hand-held radio frequency transmitter that transmits a radio frequency signal to a garage door opener such that the radio frequency signal causes an associated garage door to open or close. A head unit includes an electronic processor and a human machine interface. The electronic processor is communicatively coupled to the hand-held radio frequency transmitter and to the human machine interface. The human machine interface enables a user to activate the hand-held radio frequency transmitter via the human machine interface such that the hand-held radio frequency transmitter transmits the radio frequency signal to the garage door opener.

### CROSS-REFERENCE TO RELATED APPLICATION

This application claims benefit of U.S. Provisional Application No. 62/563,517 filed on Sep. 26, 2017, which the disclosure of which is hereby incorporated by reference in its entirety for all purposes.

### FIELD OF THE INVENTION

The disclosure relates to a remote garage door opener in a motor vehicle.

### BACKGROUND OF THE INVENTION

Not all vehicles have a garage door opener transmitter that is factory-installed. Original equipment manufacturers (OEMs) have their own solution of including buttons for garage door operation. Some OEMs put the button in the overhead center console, some put the button in the sun-visor, some integrate the button in the rearview mirror. Some vehicle trims do not have a garage opener feature at all.

In the United States, however, a garage door opener may be considered a necessity. Thus, some users use aftermarket solutions that the garage door manufacturer offers. For example, a garage door opener transmitter that clips onto the sun visor may be provided. A problem, however, is that there is a limit to number of physical buttons that can be provided on the transmitter or that can be permanently installed on a vehicle.

### SUMMARY

The present invention may provide a USB (or other wired or wireless) interface on a garage door opener transmitter device. The USB interface may enable the transmitter device to be connected to the vehicle head unit (e.g., the “host”), similarly to other USB devices. According to the invention, the head unit may be the primary interface device. Throughout this document the words “head unit” are used to refer to a car radio which provides a primary interface to various electronic devices and is also a human machine interface (HMI) (touch screen or touch pad) for the user. The present invention may provide a sophisticated human machine interface (e.g., a remote switch) on a head unit to operate (e.g., open and close) a garage door. The user may connect the transmitter device to the head unit and operate the garage door using the HMI on the head unit.

In one embodiment, the invention comprises a garage door opener arrangement for a motor vehicle, including a mobile, hand-held radio frequency transmitter that transmits a radio frequency signal to a garage door opener such that the radio frequency signal causes an associated garage door to open or close. A head unit includes an electronic processor and a human machine interface. The electronic processor is communicatively coupled to the hand-held radio frequency transmitter and to the human machine interface. The human machine interface enables a user to activate the hand-held radio frequency transmitter via the human machine interface such that the hand-held radio frequency transmitter transmits the radio frequency signal to the garage door opener.

The radio frequency transmitter may be an existing garage door opener that is commercially available on the market. The invention may provide a wired/wireless interface to such a device and implement a sophisticated HMI for the user.

In another embodiment, the invention comprises a method for controlling operation of at least one garage door, including providing within a motor vehicle a head unit including an electronic processor and a human machine interface. The electronic processor is communicatively coupled to the human machine interface. A user interacting with the human machine interface is sensed. In response to the sensing, a radio frequency signal is caused to be transmitted from a mobile, hand-held radio frequency transmitter disposed within the motor vehicle to a garage door opener such that the radio frequency signal causes an associated garage door to open or close.

In yet another embodiment, the invention comprises an infotainment head unit for a motor vehicle. The head unit includes an electronic processor communicatively coupled to a hand-held, mobile radio frequency transmitter. A human machine interface is communicatively coupled to the electronic processor. The human machine interface enables a user to activate the hand-held radio frequency transmitter via the human machine interface such that the hand-held radio frequency transmitter transmits a radio frequency signal to a garage door opener such that the radio frequency signal causes an associated garage door to open or close.

The invention may provide new cars with the capability to operate old garage door openers.

The invention may eliminate the need to have physical buttons for garage door operation.

The invention may provide a sophisticated HMI for garage door opening. A more intuitive HMI may possibly be provided using information from a navigation system, for example, which is part of the head unit.

There is no limit on the number of garage doors that can be operated by use of the present invention.

An advantage of the present invention is that the user need not replace an old garage door control unit just because it is incompatible with new configurations provided by new vehicles.

Another advantage of the present invention is that vehicles that are already on the road with touch screen interfaces can receive a software upgrade in order to gain the benefit of the present invention.

Yet another advantage of the present invention is that it may eliminate the need to clip garage door transmitters onto a vehicle's sun visor.

A further advantage of the present invention is that the task of opening/closing a garage door is made easier for a user.

### BRIEF DESCRIPTION OF THE DRAWINGS

A better understanding of the present invention will be had upon reference to the following description in conjunction with the accompanying drawings.

FIG. 1 is a block diagram of one example embodiment of a garage door opener arrangement of the present invention for a motor vehicle.

FIG. 2 is a plan view of one example embodiment of a graphic layout for the HMI of the arrangement of FIG. 1.

FIG. 3 is a flow chart of one example embodiment of a method of the present invention for controlling operation of at least one garage door.

### DETAILED DESCRIPTION OF THE PREFERRED EMBODIMENTS

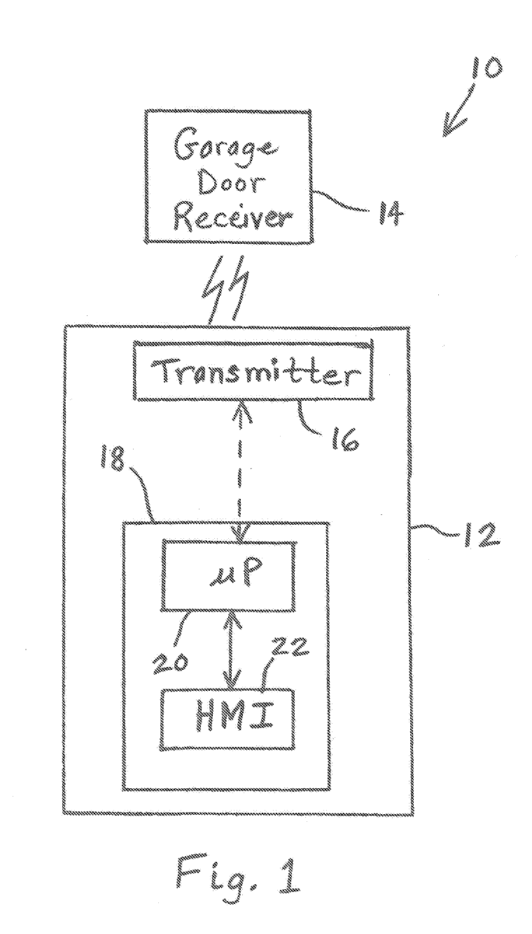

FIG. 1 illustrates one example embodiment of a garage door opener arrangement 10 of the present invention for a motor vehicle 12. Arrangement 10 includes a garage door radio frequency (RF) receiver 14, an RF transmitter 16, and a head unit 18 having an electronic processor 20 and a user interface in the form of HMI 22. Receiver 14 may be disposed in the garage in which vehicle 12 is kept and may be capable of causing an associated garage door to open and close.

Transmitter 16 may be permanently installed in vehicle 12, or may be a mobile, hand-held device that may be hand carried by the user out of vehicle 12 and possibly brought into, and used in, other vehicles. Transmitter 16 may be communicatively coupled to processor 20 via a USB connector, for example.

Head unit 18 may be part of an infotainment system of vehicle 12. Thus, HMI 22 may be used by a user to control an AM/FM radio, a navigation system, etc., in addition to being used to control transmitter 16.

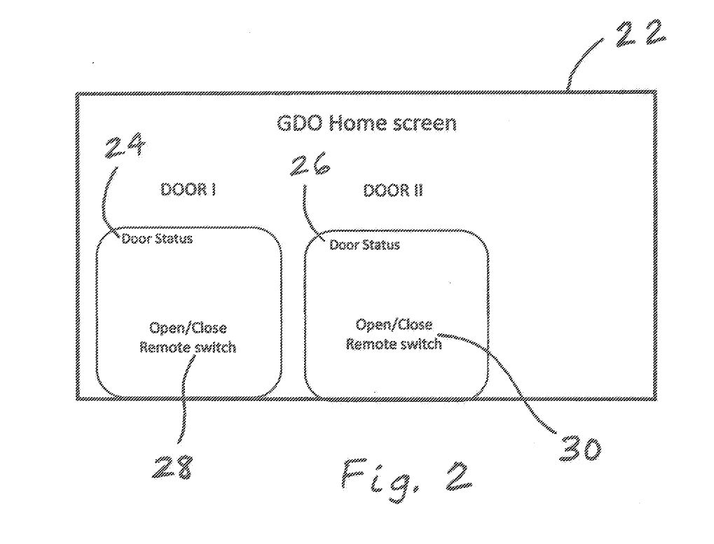

FIG. 2 illustrates one example embodiment of a touch screen or touch pad layout for HMI 22. HMI 22 may function as a remote switch to operate two garage doors I and II, and may display the status (e.g. open, opening, closed, closing) of each door, as at 24 and 26. Garage door receiver 14 may also function as a transmitter to transmit to processor 20 the status of each door.

HMI 22 may also include touch-sensitive areas 28 and 30 that the user can touch in order to open or close a respective one of the two garage doors. Transmitter 16 may transmit different RF signals in response to the user touching areas 28 and 30 such that the user may independently control the operation of two different garage doors.

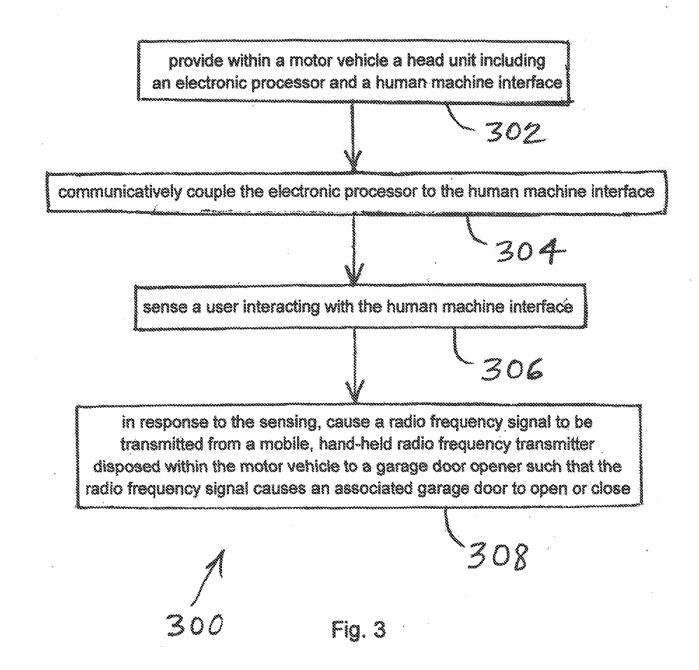

FIG. 3 illustrates chart of one example embodiment of a method of the present invention for controlling operation of at least one garage door. In a first step 302, a head unit including an electronic processor and a human machine interface is provided within a motor vehicle. For example, a head unit 18 having an electronic processor 20 and a user interface in the form of HMI 22 may be provided within motor vehicle 12.

Next, in step 304, the electronic processor is communicatively coupled to the human machine interface. For example, processor 20 may be electrically connected to HMI 22 such that processor 20 and HMI 22 may communicate with each other.

In a next step 306, a user interacting with the human machine interface is sensed. For example, processor 20 may detect a user touching touch-sensitive areas 28 and 30 on HMI 22.

In a final step 308, in response to the sensing, a radio frequency signal is caused to be transmitted from a mobile, hand-held radio frequency transmitter disposed within the motor vehicle to a garage door opener such that the radio frequency signal causes an associated garage door to open or close. For example, transmitter 16 may transmit RF signals in response to the user touching areas 28 and 30. The RF signals may be received by garage door receiver 14 which then causes a garage door to open or close in response.

The invention has been described as including a USB connection between the transmitter device and the head unit. However, it is to be understood that the scope of the present invention may encompass other communication technologies (wired or wireless) on the garage door transmitter, such as controller area network (CAN), local interconnect network (LIN) or Bluetooth, for example.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A garage door opener arrangement for a motor vehicle, the arrangement comprising:
a mobile, hand-held radio frequency transmitter configured to transmit a radio frequency signal to a garage door opener such that the radio frequency signal causes an associated garage door to open or close; and
a head unit including an electronic processor and a human machine interface, the electronic processor being communicatively coupled to the hand-held radio frequency transmitter and to the human machine interface, the human machine interface being configured to enable a user to activate the hand-held radio frequency transmitter via the human machine interface such that the hand-held radio frequency transmitter transmits the radio frequency signal to the garage door opener.

2. The arrangement of claim 1 wherein the head unit is permanently installed in the motor vehicle.

3. The arrangement of claim 1 wherein the electronic processor is communicatively coupled to the hand-held radio frequency transmitter via a USB connector.

4. The arrangement of claim 1 wherein the human machine interface includes a touch-sensitive display screen or touch pad, the human machine interface being configured to enable a user to activate the hand-held radio frequency transmitter via the touch-sensitive screen or touch pad.

5. The arrangement of claim 1 wherein the human machine interface includes an indication of whether the associated garage door is open or closed.

6. The arrangement of claim 1 wherein the electronic processor is communicatively coupled to the hand-held radio frequency transmitter via a wireless connection.

7. The arrangement of claim 1 wherein the human machine interface is configured to enable a user to independently control a plurality of garage doors.

8. A method for controlling operation of at least one garage door, the method comprising:
providing within a motor vehicle a head unit including an electronic processor and a human machine interface;
communicatively coupling the electronic processor to the human machine interface;
sensing a user interacting with the human machine interface; and
in response to the sensing, causing a radio frequency signal to be transmitted from a mobile, hand-held radio frequency transmitter disposed within the motor vehicle to a garage door opener such that the radio frequency signal causes an associated garage door to open or close.

9. The method of claim 8 further comprising permanently installing the head unit in the motor vehicle.

10. The method of claim 8 further comprising communicatively coupling the electronic processor to the hand-held radio frequency transmitter via a USB connector.

11. The method of claim 8 further comprising:
providing the human machine interface with a touch-sensitive screen; and
enabling a user to activate the hand-held radio frequency transmitter via the touch-sensitive screen.

12. The method of claim 8 further comprising using the human machine interface to provide an indication of whether the associated garage door is open or closed.

13. The method of claim 8 further comprising communicatively coupling the electronic processor to the hand-held radio frequency transmitter via a wireless connection.

14. The method of claim 8 further comprising enabling a user to independently control a plurality of garage doors via the human machine interface.

15. An infotainment head unit for a motor vehicle, the head unit comprising:
an electronic processor configured to be communicatively coupled to a hand-held, mobile radio frequency transmitter; and
a human machine interface communicatively coupled to the electronic processor, the human machine interface being configured to enable a user to activate the hand-held radio frequency transmitter via the human machine interface such that the hand-held radio frequency transmitter transmits a radio frequency signal to a garage door opener such that the radio frequency signal causes an associated garage door to open or close.

16. The arrangement of claim 15 wherein the head unit is permanently installed in the motor vehicle.

17. The arrangement of claim 15 wherein the electronic processor is configured to be communicatively coupled to the hand-held radio frequency transmitter via a USB connector.

18. The arrangement of claim 15 wherein the human machine interface includes a touch-sensitive display screen, the human machine interface being configured to enable a user to activate the hand-held radio frequency transmitter via the touch-sensitive screen.

19. The arrangement of claim 15 wherein the human machine interface includes an indicator configured to indicate to a user whether the associated garage door is open or closed.

20. The arrangement of claim 15 wherein the electronic processor is configured to be communicatively coupled to the hand-held radio frequency transmitter via a wireless connection.
